(19) United States
(12) Patent Application Publication
(10) Pub. No.: US 2008/0065380 A1
(43) Pub. Date: Mar. 13, 2008

(54) ON-LINE SPEAKER RECOGNITION METHOD AND APPARATUS THEREOF

(76) Inventors: Keun Chang KWAK, Daejeon (KR); Kyung Sook BAE, Gyunggi-do (KR); Ho Sub YOON, Daejeon (KR); Hye Jin KIM, Incheon (KR); Su Young CHI, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/684,691

(22) Filed: Mar. 12, 2007

(30) Foreign Application Priority Data
Sep. 8, 2006 (KR) 10-2006-87004

(51) Int. Cl. G10L 15/00

(52) U.S. Cl. 704/243

(57) ABSTRACT

A speaker recognition method and apparatus are provided. In the speaker recognition method, basic data and voice data of a speaker are received using contents that constantly request the speaker to constantly response using the speaker's voice. Then, a voice of the speaker is extracted from voice data, and a feature vector for recognition is extracted from the voice of the speaker. Based on the extracted feature vector, a speaker model is created. Then, a speaker stored in a speaker model is recognized based on information analyzed from input voice.

### CLAIM OF PRIORITY

This application claims the benefit of Korean Patent Application No. 2006-87004 filed on Sep. 8, 2006 in the Korean Intellectual Property Office, the disclosure of which is incorporated herein by reference.

### BACKGROUND OF THE INVENTION

1. Field of the Invention

The present invention relates to a method and apparatus for speaker recognition.

2. Description of the Related Art

According to the development of robot technology, home service robots providing various services have been produced and introduced. Such home service robots have been advanced to provide complicated and high-level services according to the development of related technology fields. Accordingly, it has been required to develop a technology that enables a robot to identify family members through speaker recognition. As the speaker recognition technology, the necessity of recognizing a speaker based on voice thereof as well as a face has increased.

A speaker registration technology for speaker recognition using voice was not developed or introduced for a robot environment. The speaker registration technology is developed for a security field. The well-known speaker registration methods are a text-dependent speaker recognition method, a text-prompted speaker recognition method, and a text-independent speaker recognition method.

In the text-independent speaker recognition method, a speaker is recognized based on a generalized background model for the phonetic characteristic of a target speaker to recognize. In this method, a speaker is not required to participate to complicated procedures. Advantageously, it is possible to naturally recognize a speaker without asking the complicated procedures to follow. However, in order to recognize a speaker using this method, the background models need to be generated based on generalized features for a plurality of speakers' voices. It requires such a long time and lots of efforts. Also, this method has a problem that the recognition rate is greatly influenced by the background models.

In the text-dependent speaker recognition method, a speaker is registered by asking a speaker to read a previously known text. In the text-prompted speaker recognition method, a speaker is registered by asking a speaker to read a text or consecutive numbers, which are randomly selected in a predetermined rule. These two methods have advantages of convenience to embody and utilize the methods because the voices of speakers are previously recorded, and it asks a speaker to read less texts using the pre-selected numbers and texts for registration.

The phonetic characteristics of the speakers may be not sufficiently due to less and short texts to read for registration. Therefore, the recognition rate may be lowered. That is, these methods are not suitable for a robot that must provide an excellent recognition performance to any texts.

Also, a home service robot is required to naturally adapt voices of family members and register the family members based on the adapted voices rather than an off-line method that previously sets data related to voices of family members. Furthermore, the home service robot is required to update the voice data of the registered speakers according to time and environment variations.

Since the speaker recognition of the home service robot is continuously influenced by various regular or irregular noises made in home environment or noises made by the robot, it is required to be durable against the general noise.

### SUMMARY OF THE INVENTION

The present invention has been made to solve the foregoing problems of the prior art and therefore an aspect of the present invention is to provide a speaker recognition method including an on-line speaker registration method.

Another aspect of the invention is to provide a speaker recognition method for dynamically adapting voice data of a registered speaker according to time variation and environment variation.

Still another aspect of the invention is to provide a speaker recognition method durable against general noise.

According to an aspect of the invention, the invention provides a speaker recognition method including: receiving basic data and voice data of a speaker using contents that constantly request the speaker to constantly response using the speaker's voice; extracting only a voice of the speaker from voice data; extracting a feature vector for recognition from the voice of the speaker; creating a speaker model from the extracted feature vector; and recognizing a speaker stored in a speaker model based on information analyzed from input voice.

According to another aspect of the invention, the invention provides a computer readable recording medium for recording a program that implements a speaker recognition method, including: receiving basic data and voice data of a speaker using contents that constantly request the speaker to constantly response using the speaker's voice; extracting only a voice of the speaker from voice data; extracting a feature vector for recognition from the voice of the speaker; creating a speaker model from the extracted feature vector; and recognizing a speaker stored in a speaker model based on information analyzed from input voice.

According to further another aspect of the invention, the invention provides a speaker recognition apparatus including: a contents storing unit for storing contents that requests a speaker to constantly response using voice; an output unit for outputting the contents externally; a contents managing unit for controlling the output unit to output the contents stored in the contents storing unit; a voice input unit for receiving voice data of a speaker generated in response to the contents; a voice extracting module for extracting only a voice of a speaker by removing sound related to the contents from the voice signal; a feature vector extraction module for extracting a feature vector from a voice of the extracted voice of the speaker; a speaker model generation module for generating a speaker model of a speaker based on the extracted feature vector; a speaker model training model for adapting a speaker model of a speaker based on the extracted feature vector; a memory for storing information related to a speaker model; and a speaker recognition module for recognizing a speaker by searching speaker model stored in the memory based on the extracted feature vector.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flowchart illustrating a speaker recognition method according to an exemplary embodiment of the present invention; and

FIG. 2 is a block diagram illustrating a speaker recognition apparatus according to an exemplary embodiment of the present invention.

### DETAILED DESCRIPTION OF THE PREFERRED EMBODIMENT

Exemplary embodiments of the present invention will now be described in detail with reference to the accompanying drawings.

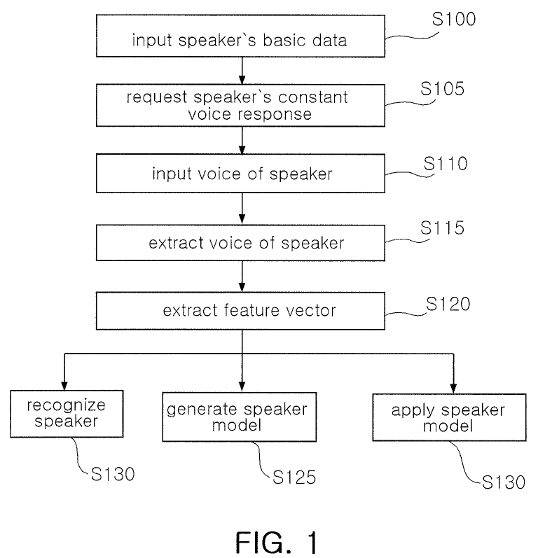

Hereinafter, a speaker recognition method according to an exemplary embodiment of the present invention will be described with reference to FIG. 1 in detail.

FIG. 1 is a flowchart illustrating a speaker recognition method according to an exemplary embodiment of the present invention.

At step S100, basic data of a speaker is inputted for allocating an identification sign to a target speaker to recognize. Since the number of family members is more than two, a service robot used in a home needs to discriminate one speaker from others. In the present embodiment, it is required to allocate unique identification signs to speakers that are recognized as different family members through the speaker recognition method according to the present embodiment. It is preferable that a name or a nickname of a speaker, which is inputted through an external input device such as a keyboard and a touch screen, can be used as the identification sign.

After allocating the identification signs to a speaker to recognize, it constantly requests the speaker to constantly response to the requests using the speaker's voice at step S105. It is for learning a statistical model by collecting a plurality of speakers' voices, and for naturally performing a recognition operation using the learned model. In order to make a speaker to response to the request at the step S105, it is preferable to use predetermined contents produced using a speaker's voice. It is preferable that the predetermined contents include music contents to make a speaker to sing along by playing music, game contents to make a speaker to response using voice while playing a game, and educational contents to make a speaker to response using voice while learning.

When a speaker responses to the request of the step S105 using the voice, the voice of the speaker is inputted at step S110. In order to receive the speaker's voice, a microphone can be used as a voice input unit.

After inputting the voice of the speaker, the speaker's voice is extracted from voice data produced by inputting the speaker's voice at step S115. The voice data inputted at the step S110 includes noise around the speaker or sound related to the contents used at the step S106. Therefore, the voice data inputted at step S110 is not suitable to collect voices of a plurality of speakers, learn the statistical model thereof, and perform a recognition operation using the learned model. Thus, it is required to extract the voice of the speaker from the voice data. Herein, a noise cancellation filter such as a wiener filter can be used to remove the noise around the speaker. The sound from the contents used at the step S105 can be removed easily by removing related data from the voice data because the sound is already known waveforms.

After extracting the voice of the speaker from the voice data, a feature vector is extracted from the voice of the speaker for speaker recognition at step S120. That is, when a voice inputted through a microphone inputs to a system, a feature vector, which can properly express phonetic characteristics of a speaker, are extracted at every 1/100 second. Such vectors must excellently express the phonetic characteristics of the speaker and also be insensible to differences, pronunciation, and attitude of a speaker. Representative methods for extracting a feature vector are a linear predictive coding (PLC) extracting method that analyzes all frequency bands with equivalent weights, a mel frequency cepstral coefficients (MFCC) extracting method that extracts feature vectors using the characteristic that a human voice recognition pattern flows a mel scale similar to a log scale, a high frequency emphasis extracting method that emphasizes high frequency elements for clearly discriminating voice from noise, and a window function extracting method for minimizing distortion caused by diving voice into short periods. It is preferable to use the MFCC extracting method among them to extract the feature vector.

After extracting the feature vector from the voice data of a speaker, a speaker model is generated by parameterizing feature vector distribution of the speaker at step S125. In order to create the speaker model, a Gaussian mixture model (GMM), a hidden markove model (HMM), and a neural network are used. It is preferable to the GMM to create the speaker model in the present embodiment.

The distribution of feature vectors extracted from voice data of a speaker is performed by Gaussian mixture density. For a D-dimensional feature vector, a mixture density of a speaker can be expressed as follow Equation 1.

$$p ( \vec{x} \vert {λ}_{s} ) = {\sum }_{i = 1}^{M} {ω}_{i} {b}_{i} ( \vec{x} ) \\ {b}_{i} ( \vec{x} ) = \frac{1}{{( 2 π )}^{D / 2} {\vert Σ \vert}^{1 / 2}} exp ( - \frac{1}{2} {( \vec{x} - {μ}_{i} )}^{T} {( {Σ}_{i} )}^{- 1} ( \vec{x} - {μ}_{i} ) ) \qquad Equation 1$$

In Equation 1, wᵢ denotes a mixture weight, and bᵢ denotes a probability obtained through a Gaussian mixture model. Herein, the density is a weighted linear sum of a mean vector and M Gaussian mixture models parameterized by covariance matrix.

Then, a speaker stored in a speaker model is recognized based on analyzed information from the input voice at step S130. The speaker recognition is performed using the identification sign allocated at the step S100.

In order to recognize a speaker, a parameter of a Gaussian mixture model is estimated when voice is inputted from a speaker. A maximum likelihood estimation is used as the parameter estimation method. The likelihood of a Gaussian mixture model for a probability can be expressed as following Equation 2.

$$p ( X \vert {λ}_{s} ) = {\prod }_{t = 1}^{T} p ( \vec{{x}_{t}} \vert {λ}_{s} ) \qquad Equation 2$$

In Equation 2, the parameters of a speaker model are a weight, a mean, and i=1, 2, . . . M formed of covariance. The maximum likelihood parameter is estimated using an expectation—maximization (EM) algorithm. When one of family members speaks, a speaker is searched through finding a speaker model having a maximum posteriori probability. This method of searching a speaker can be expressed by following Equation 3.

$$\hat{S} = \text{arg} max {\sum }_{t = 1}^{T} log p ( \vec{{x}_{t}} \vert {λ}_{k} ) \qquad Equation 3$$

In the present embodiment, at step S130, a previously generated speaker model is adapted using continuously inputted speaker's voice. A Bayesian adaptation is well known as a method of obtaining adapted speaker model. In order to adjust the speaker model, the adapted speaker model is obtained through changing weight, means and variances. This method is similar to a method of obtain an adapted speaker model using generalized background model. Hereinafter, three methods will be described with related Equations.

The j^{th} Gaussian mixture model of a registered speaker is calculated by a following Equation 4.

$$p ( j \vert \vec{{x}_{i}} ) = \frac{{ω}_{j} {b}_{j} ( \vec{{x}_{t}} )}{{\sum }_{t = 1}^{M} {ω}_{j} {b}_{j} ( \vec{{x}_{t}} )} \qquad Equation 4$$

Each weight, mean and variance parameter are calculated through statistical calculation as like Equation 5.

$${n}_{i} = {\sum }_{t = 1}^{T} p ( j \vert \vec{{x}_{t}} ) \\ {E}_{i} ( \vec{x} ) = \frac{1}{{n}_{t}} {\sum }_{t = 1}^{T} p ( j \vert \vec{{x}_{t}} ) \vec{{x}_{t}} \\ {E}_{i} ( \vec{{x}^{2}} ) = \frac{1}{{n}_{t}} {\sum }_{t = 1}^{T} p ( i \vert \vec{{x}_{t}} ) \vec{{x}_{t}^{2}} \qquad Equation 5$$

Based on these parameters, the adapted parameters of the j^{th} mixture model can be obtained from the sum of adaptation coefficients. Finally, a new speaker model for a voice varying according to time and environment can be generated.

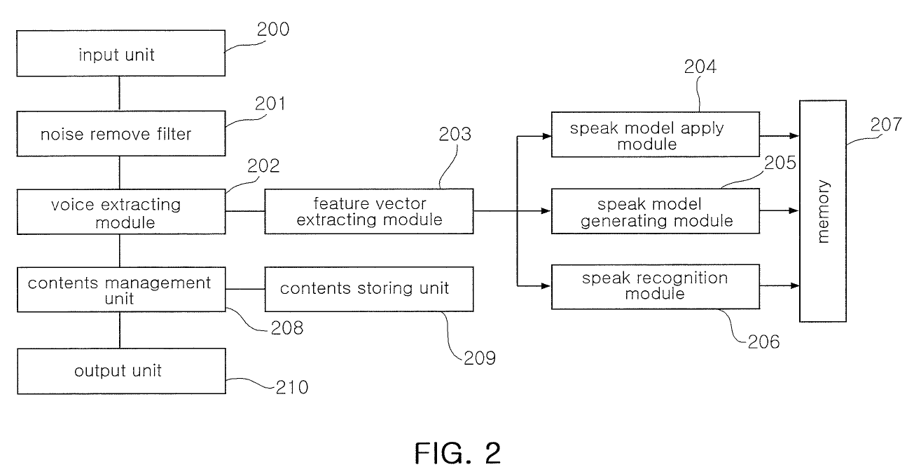

Hereinafter, a speaker recognition apparatus according to an exemplary embodiment of the present invention will be described with reference to FIG. 2 in detail.

FIG. 2 is a block diagram illustrating a speaker recognition apparatus according to an exemplary embodiment of the present invention.

A contents storing unit 209 stores contents for requesting a speaker to constantly response using the speaker's voice. It is preferable that the predetermined contents include music contents to make a speaker to sing along by playing music, game contents to make a speaker to response using voice while playing a game, and educational contents to make a speaker to response using voice while learning. A contents management unit 208 manages the contents stored in the contents storing unit 209 to output to a speaker through an output unit 210.

An input unit 200 includes a voice input unit such as a microphone for receiving voice data of a speaker generated corresponding to the contents, and a general input unit such as a key board or a touch screen in order to receive an identification sign such as a name or a nick name of a voice inputted speaker.

A voice extracting module 202 is a device for extracting a voice of a speaker from a voice signal inputted through the input unit 200. It is preferable to use a noise cancellation filter 201 such as a wiener filter for canceling the noise from the voice signal inputted through the input unit 200.

After extracting the voice of a speaker by the voice extracting module 202, a feature vector extracting module 203 extracts a feature vector required for speaker recognition. That is, when the voice inputted through the input unit 200 enters into a system, feature vectors that can properly express phonetic characteristics of a speaker are extracted at every 1/100 second.

A speaker model generation module 205 creates a speaker model by parameterizing feature vector distribution of voice data of the extracted speaker, and the created speaker model is stored in a memory 207.

A speaker recognition module 206 recognizes a speaker by searching a speaker model stored in the memory 207 based on the feature vector of the voice data of the extracted speaker.

Herein, the speaker model adaptation module 204 updates the speaker model stored in the memory in order to adapt the generated speaker model using continuously inputted voice data by the contents.

As set forth above, according to exemplary embodiments of the invention, the speaker recognition method including the on-line speaker registration method naturally and adaptively performed in a home service robot is provided. Also, according to exemplary embodiments of the invention, the speaker recognition method that can adapt voice data of a registered speaker according to time and environment variations is provided.

While the present invention has been shown and described in connection with the preferred embodiments, it will be apparent to those skilled in the art that modifications and variations can be made without departing from the spirit and scope of the invention as defined by the appended claims.

What is claimed is:

1. A speaker recognition method comprising:
receiving basic data and voice data of a speaker using contents that constantly request the speaker to constantly response using the speaker's voice;
extracting only a voice of the speaker from voice data;
extracting a feature vector for recognition from the voice of the speaker;
creating a speaker model from the extracted feature vector; and
recognizing a speaker stored in a speaker model based on information analyzed from input voice.

2. The speaker recognition method according to claim 1, further comprising: receiving basic data of a speaker to be recognized before the step of receiving basic data and voice data.

3. The speaker recognition method according to claim 2, wherein the basic data of the speaker is a name of the speaker.

4. The speaker recognition method according to claim 1, wherein the contents are music contents, game contents, or educational contents.

5. The speaker recognition method according to claim 1, wherein the step of extracting only the voice includes canceling noise from the voice data and removing sound related to the contents from the voice data.

6. The speaker recognition method according to claim 1, wherein in the step of extracting the feature vector, a MFCC (mel frequency cepstral coefficients) extracting method is used.

7. The speaker recognition method according to claim 1, wherein in the step of creating the speaker mode, the speaker model is created using a Gaussian mixture model.

8. The speaker recognition method according to claim 1, wherein in the step of recognizing the speaker, the analyzed information from the input voice is a likelihood obtained through Equation:
$$p ( X \vert {λ}_{s} ) = {\prod }_{t = 1}^{T} p ( \vec{{x}_{t}} \vert {λ}_{s} ) ,$$
where parameters of a speaker model are a weight, a mean, and i=1, 2, . . . M formed of covariance, and
the stop of recognizing the speaker stored in the speaker mode based on the information is a procedure of fining a speaker model having a maximum posteriori probability obtained through Equation:
$$\hat{S} = \text{arg} max {\sum }_{t = 1}^{T} log p ( \vec{{x}_{t}} \vert {λ}_{k} ) .$$

9. The speaker recognition method according to claim 1, further comprising adapting a previously generated speaker model using a feature vector extracted from a voice of a speaker.

10. The speaker recognition method according to claim 9, wherein in the step of adapting the previously generated speaker mode, a j^{th} Gaussian mixture mode of the previously generated speaker model is calculated using Equation:
$$p ( j \vert \vec{{x}_{i}} ) = \frac{{ω}_{j} {b}_{j} ( \vec{{x}_{t}} )}{{\sum }_{t = 1}^{M} {ω}_{j} {b}_{j} ( \vec{{x}_{t}} )} ,$$
and a new speaker model is created by calculating weight, mean, and variance parameters, and obtaining adapted parameters of the j^{th} mixture model from a sum of adaptation coefficients based on the calculated weight, mean, and variance parameters, wherein the weight, mean and variance parameters are calculated using Equation:
$${n}_{i} = {\sum }_{t = 1}^{T} p ( j \vert \vec{{x}_{t}} )$$
$${E}_{i} ( \vec{x} ) = \frac{1}{{n}_{t}} {\sum }_{t = 1}^{T} p ( j \vert \vec{{x}_{t}} ) \vec{{x}_{t}}$$
$${E}_{i} ( \vec{{x}^{2}} ) = \frac{1}{{n}_{t}} {\sum }_{t = 1}^{T} p ( i \vert \vec{{x}_{t}} ) \vec{{x}_{t}^{2}} .$$

11. A computer readable recording medium for recording a program that implements a speaker recognition method, comprising:
receiving basic data and voice data of a speaker using contents that constantly request the speaker to constantly response using the speaker's voice;
extracting only a voice of the speaker from voice data;
extracting a feature vector for recognition from the voice of the speaker;
creating a speaker model from the extracted feature vector; and
recognizing a speaker stored in a speaker model based on information analyzed from input voice.

12. A speaker recognition apparatus comprising:
a contents storing unit for storing contents that requests a speaker to constantly response using voice;
an output unit for outputting the contents externally;
a contents managing unit for controlling the output unit to output the contents stored in the contents storing unit;
a voice input unit for receiving voice data of a speaker generated in response to the contents;
a voice extracting module for extracting only a voice of a speaker by removing sound related to the contents from the voice signal;
a feature vector extraction module for extracting a feature vector from a voice of the extracted voice of the speaker;
a speaker model generation module for generating a speaker model of a speaker based on the extracted feature vector;
a speaker model training model for adapting a speaker model of a speaker based on the extracted feature vector;
a memory for storing information related to a speaker model; and
a speaker recognition module for recognizing a speaker by searching speaker model stored in the memory based on the extracted feature vector.

13. The speaker recognition apparatus according to claim 12, further comprising:
an input unit for receiving a name of each speaker who inputs voice through the voice input unit as an identification sign.

14. The speaker recognition apparatus according to claim 12, wherein the contents stored in the contents storing unit are music contents, game contents, or educational contents.

15. A home service robot comprising:
a speaker recognition apparatus including:
a contents storing unit for storing contents that requests a speaker to constantly response using voice;
an output unit for outputting the contents externally;
a contents managing unit for controlling the output unit to output the contents stored in the contents storing unit;
a voice input unit for receiving voice data of a speaker generated in response to the contents;
a voice extracting module for extracting only a voice of a speaker by removing sound related to the contents from the voice signal;
a feature vector extraction module for extracting a feature vector from a voice of the extracted voice of the speaker;
a speaker model generation module for generating a speaker model of a speaker based on the extracted feature vector;
a speaker model training model for adapting a speaker model of a speaker based on the extracted feature vector;
a memory for storing information related to a speaker model; and
a speaker recognition module for recognizing a speaker by searching speaker model stored in the memory based on the extracted feature vector.

16. The home service robot according to claim 15, wherein the speaker recognition apparatus further includes an input unit for receiving a name of each speaker who inputs voice through the voice input unit as an identification sign.

17. A home service robot according to claim 15, wherein the contents stored in the contents storing unit are music contents, game contents, or educational contents.
